(19) United States
(12) Patent Application Publication
(10) Pub. No.: US 2007/0125871 A1
(43) Pub. Date: Jun. 7, 2007

(54) Imaging system with liquid pixels

(75) Inventor: Robert Wysocki, Las Vegas, NV (US)

Correspondence Address: Mark A. Litman & Associates, P.A., York Business Center, Suite 205, 3209 West 76th St., Edina, MN, 55435, US

(73) Assignee: The Board of Regents of the NV. System of Higher Education, on behalf of the University of NV.

(21) Appl. No.: 11/593,801

(22) Filed: Nov. 7, 2006

Related U.S. Application Data
(60) Provisional application No. 60/738,617, filed on Nov. 21, 2005.

(51) Int. Cl. B05B 17/04

(52) U.S. Cl. 239/12; 239/16; 239/17; 239/211; 239/69

(57) ABSTRACT

Liquid (e.g., water) is provided in a relatively vertical or supported display with segments of water (either vertically propelled or vertically falling), with the segments being controlled in their relative orientation to act as pixels in forming viewable images in a fountain or confined liquid display. The segments may be moving upwardly or downwardly in displays.

### BACKGROUND OF THE INVENTION

1. Field of the Invention

The present invention relates to the field of water displays and fountains, and more particularly the invention relates to imaging displays effected through the use of segments of water acting as pixels in forming viewable images in a display. The invention relates to closed displays within a container, defined borders or to open containers bounded only by the limits of water direction in open air.

2. Background of the Art

Fountains have been used as decorative structures for thousands of years. Fountains have been referred to in literature and entertainment as a unique and wondrous artistic display. Over the years, different formats of fountains as art have been developed, ranging from simple vertical emissions, stream emissions, statuary emitting water in unique displays (e.g., La Pissant), fountains where the water creates an artistic design (e.g., the Dandelion fountain in Loring Park in Minneapolis, Minn.), and most recently, the choreographed fountains at the Bellagio in Las Vegas, Nev.).

Disneyworld® theme park has a series of fountains in which streams of water are sent from one fountain to an adjacent fountain and then from the adjacent fountain to another fountain to provide an apparent relay of the stream of water from one location to another.

The fountains at the Bellagio Hotel and Casino in Las Vegas, Nev. have attracted international attention. A series of hundreds of fixed water cannons are supported on a frame that is covered with water. The individual heads are computer controlled and can have the intensity of the water varied, and the angle of emission varied by remote control. The emissions are choreographed in conjunction with broadcast music so that the water and music are synchronized in form. The bursts from the water cannons can be controlled for intensity (which results in changes in the height of the stream or burst from the individual water cannon heads), duration and to some degree the angle of the emission. The fountains have become a symbol of Las Vegas.

Other patented technology relating to images with liquids include U.S. Pat. No. 4,111,363, Portable Water Fountain Display Apparatus; U.S. Pat. No. 5,603,454 Water display pendant water dropper; U.S. Pat. No. 5,553,779 Air powered water display nozzle unit; U.S. Pat. No. 5,480,094 Air powered water display nozzle unit; U.S. Pat. No. 5,363,577 Alphanumeric and graphic water display; U.S. Pat. No. 5,340,024, Numerically controlled water jet display pool; U.S. Pat. No. 4,889,283 Apparatus and method for stream diverter; U.S. Pat. No. 4,817,312, User activated fountain display; U.S. Pat. No. 4,795,092, Laminar flow nozzle; U.S. Pat. No. 5,106,660, Decorative wall panel; U.S. Pat. No. 4,892,250, Dynamic fountain displays and methods for creating the same; U.S. Pat. No. 4,852,801, Air powered water displays; U.S. Pat. No. 6,079,635, Water Display Nozzle Shields; and U.S. Pat. No. 5,934,558 Water display with multiple characteristics.

These systems do not enable a rich and relatively persistent display of images. For example, U.S. Pat. No. 5,363,577 describes a liquid display that has a plurality of adjacent parallel tubes filled with a fluid and connected to a source of air that introduces bubbles into the tubes, so that the combination of bubbles form a word, or another recognizable graphic display. Each tube has a valve connected to the air supply, that controls the duration and flow rate of air injected into the tube so that a single bubble is formed within the tube. The valves are connected to a computer that opens and closes each valve to produce a pattern of bubbles in accordance with a computer program within the computer. The program creates a combination of bubbles that together depict a legible design or display. The bubbles are inherently unstable, move erratically, break down or enlarge, and move at different rates through the tubes, allowing for a poor image.

### SUMMARY OF THE INVENTION

Liquid (e.g., water, aqueous solutions, aqueous suspensions, aqueous/oil emulsions, etc.) is provided in a vertical display or near vertical display with segments of water (either vertically propelled or vertically falling), with the segments being controlled in their relative orientation to act as pixels in forming viewable images in a fountain or liquid display.

### BRIEF DESCRIPTION OF THE FIGURES

FIG. 1 shows a series of water projecting heads with segments provided that act as pixels in a viewable image.

FIG. 2 shows an alternate presentation of heads to effect a three dimensional effect.

FIG. 3 shows an alternate presentation of water segment sources that form a cascading image forming system. The liquid segments are also shown against a curved backdrop that allows control of the persistence of water pixel images.

### DETAILED DESCRIPTION OF THE INVENTION

In the digital imaging art, it is understood that images can be constructed from pixels. Pixels are the smallest component of an image and were contemplated by the painting style of pointillism developed by the painter George Seurat. The pixels are viewed from a distance, and the eyes of a viewer perceive an image and either tend to ignore the individual pixels or accept a grainy character to an image resulting from sensing of the pixels.

The present technology uses the pixel concept by providing moving segments of water that are distributed in 2-dimensional or 3-dimensional space to provide a viewable image constructed of pixels of water. Backdrops, lighting, luminescence or optical density content may be provided to enhance the visibility of the segments, although the segments are visible in the air.

The segments (which are either moving, in a gravitationally supported transition between movement and lack thereof) are provided by any controllable source of water, especially where the source can be rapidly controlled to provide relatively precise spacing between segments from a single water segment source and between adjacent segment sources so that the physical relationship between segments acting as pixels can be controlled. As a technical consideration, the speed of off/on control for the segment source (with on providing a segment of water and off providing the gap or spacing between segments) is influenced by the size of the image needed. With an extremely large image (e.g., 50 meter high and 50 meters wide), the segments and the spacing can themselves be tolerated in larger dimensions (e.g., 0.5 meter segments and spacing), while with a smaller image (e.g., 0.5 by 0.5 meters), both the segments and the spacing between segments must be smaller to allow for perceptible resolution in the image. Fast acting solenoid controls on the water, rapidly moving deflector blades, rapid stream closure systems and the like can be used as the physical control over the individual heads.

It is also possible to extend the effective viewing life of the image by temporarily supporting the pixel/water-segment image on a low hydrophilic surface over which the pixel droplets may continue to move under the force of gravity and be only mildly restrained by surface tension, while the overall pixel distribution is maintained. This is done by balancing the forces of gravity and surface tension to maintain the imagewise distribution of droplets in the intentionally created pattern.

These segment providing systems must be mechanically or electronically controlled, as hand operating of the on/off function is not feasible in a rational size for the images. The segment providing system may project segments upwardly (vertically, along an angle, in a gravity influenced curve, in a free water flow or against a support surface) or downwardly, allowing gravity to accelerate or maintain the speed of the segment movement (as when flowing against a surface). The concept of importance is to provide a viewable image constructed of pixels of liquid that can be viewed with the unassisted eye. The liquid of choice is water (pure or with additives to control optical density, viscosity, surface tension, volatility or the like), although any liquid may be used that can exhibit some transient persistence as a segment in movement.

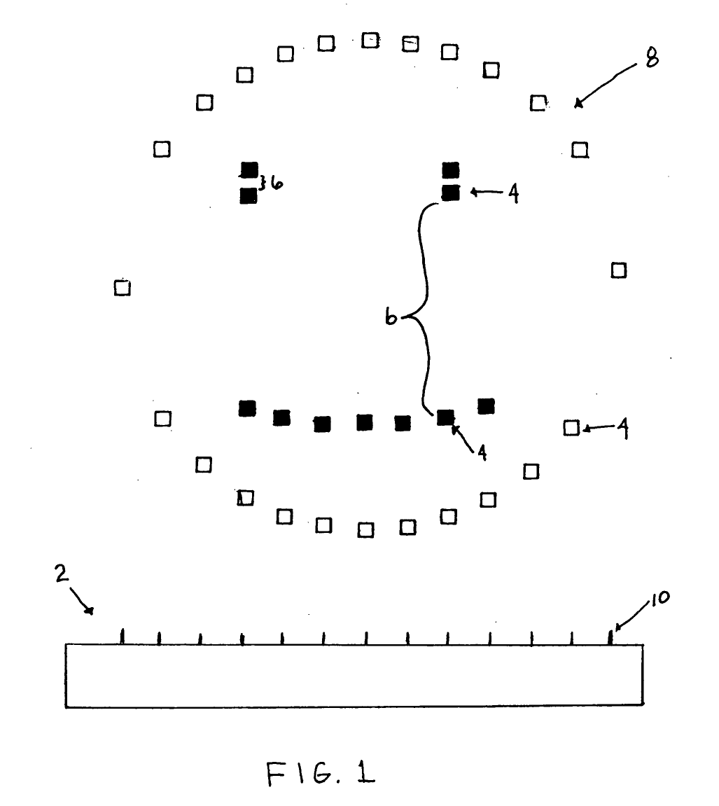

FIG. 1 shows an exemplary fountain system 2 with segments 4 and spacing 6 forming pixels that construct an image of a smiley face 8 (for simplicity). Water cannons 10 are shown in an upwardly projecting format.

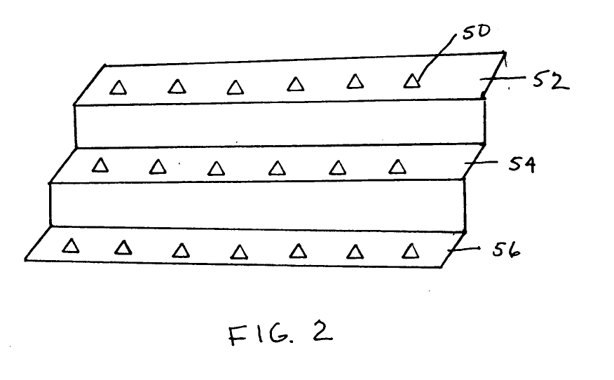

FIG. 2 shows a set of stepped liquid segment sources such as water cannons 50 with three distinct series or steps 52, 54 and 56 of water cannons 50 that enable either an enhanced three-dimensional image or a colored image (by providing pixels of different colors such as cyan, magenta and yellow).

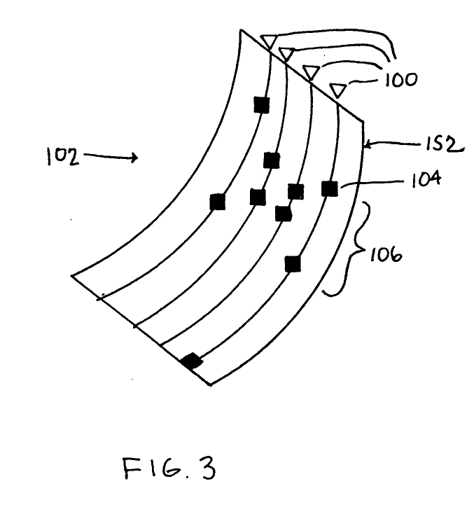

FIG. 3 shows an alternate presentation of water segment sources 100 that form a cascading image forming system 102. Here, the water segments 104 and spacing 106 are formed by controlled and timed dropping or downwardly projected segments 104 with appropriate spacing 106. This format is advantageous as less cannon head pressure might be able to provide quality images, and the format might avail itself of the use of a backdrop support along which the liquid segments may flow and on which the effects of gravity on image distortion with time may be moderated.

As indicated above, gravity influences the quality of the image by accelerating downwardly projected segments or decelerating upwardly projected images. FIG. 3 also shows water segments 104 against a curved backdrop 152 that allows control of the persistence of water pixel images. As the images will generally be viewed from a perspective having a known angle of vision, the slope and change in slope of a backdrop surface for the segments can be controlled and designed such that from a particular angle of vision, the drops appear to move at a relatively constant vertical speed. For example, if the emitted speed of the downwardly moving segment when it initial is viewable as a pixel is viewed at a relative speed of 1.0, the curve of the backdrop support is concave from the direction of view such that when the segment reaches the bottom, its angular velocity along the curve is such that it still appears to move at the relative speed of 1.0. For a simple example, if the actual linear speed of the segment at the bottom were at a relative speed of 1.414, the angle of the support surface relative to the angle of vision would be about 45 degrees (the sine of that angle being 1.0/1.414), so that a viewer would see the segment appear to be moving at a relative speed of 1.0. This curvature support would also appear to maintain approximately constant segment lengths and segment spacing.

The size of the segments and distance of the spacing, as previously indicated, are dependent upon the overall size of the image. Larger images seen from a greater distance must have larger segments and greater spacing to enable the viewers' eyes to resolve the image, at least in part because there is limited optical density difference and contrast between water segments and air. The additional of opacifying agents (e.g., dyes, dispersed pigments and the like) can assist in allowing a greater tolerance range for the segment sizes.

Software can be readily provided to control the segment sources without great complexity. The software is classic on/off digital control of signals to the segment sources, and the design of the image can be readily constructed as were the spaced percussive music boxes with spaced prongs that pluck at strings in a musically oriented pattern of music tines or strings.

When a support surface is used, especially with the downward flow of liquid, deep grooves or channels may be used to provide better and more stable horizontal directional flow along a defined path. This assists in maintaining a relative horizontal resolution to the liquid pixels. The surface of any support should generally be selected so that the surface does not have a strong affinity for the liquid. For example, if water is the liquid, the support surface should preferably be oleophilic (hydrophobic) and if the liquid were an oil, the surface would preferably be hydrophobic (oleophilic) to assure easier movement of the liquid over the surface. It may be artistic to have the grooves with parallel sinusoidal paths to slightly and controllably distort the images.

The scope and design for this system includes small format images, such as wall handing or ordinary picture images. In using liquid pixels with a gaseous air gap, this requires high speed on/off controls. It is possible to reduce the speed needed in the control by slowing down the speed of the liquid, as by including the liquid within tubing creating a horizontal limit to each segment and providing the vertical control of the pixel location. It is also possible to provide the pixel as one liquid and the spacing as an immiscible liquid within the tubing. This is a more effective way of increasing the ability of less expensive, slower on/off systems to be used in the imaging. The image must be formed initially with the segments and spacing moving through the tubes (upward, downward or horizontally, as the liquid path is now enclosed), and the image may be frozen (either literally or by stopping the motion of the liquid within the tubes). Image formation must always be created by movement of liquid across the imaging surface or volume.

Various apparatus that may be used in the performance of this technology includes, by way of non-limiting examples, A “FC-280-S Ultrafast Flow Controller” of Tylan GmbH, D-8057 Etching, could be used as the flow governor and pneumatic valves known as “Nuproventil SS4 BK-1C” of Druckluft Ebel, D-8033 Martinsried, Germany, could be used as shut-off valves for this modification; solenoid valves and microsolenoid valves; the water caccno system described in U.S. Pat. No. 4,773,357 (which is incorporated herein by reference). U.S. Pat. No. 5,624,409 (Seale) describes a dynamic controller for quantitative rapid-pulse flow control over a wide dynamic range (1000-to-1) forms a fluid path from a pressurized source. The fluid path travels from the pressure source via a fast (one millisecond or less) on-off source control valve into a volume-displacement interface area, thence to a fast on-off load control valve and on to the nozzle. The load control valve may be replaced by a passive flow restrictor where less dynamic range is required. From the reusable controller side, fast actuators are energized to open the normally-closed valves. A volume sensor mates with the volume-displacement interface area. This sensor uses an incompressible transfer fluid, typically different than and isolated from the deliverable fluid by membranes, to transmit volume displacement change into a transducer area for conversion from volume to a measurable electrical signal, typically a frequency. A known pressure/volume curve for the volume sensor allows pressure monitoring during operation, yielding knowledge of fluid source and load conditions. A flow control method relies on a combination of very short, variable valve-open pulses and design with comparatively large-diameter fluid passageways into the fluid capacitance of the volume sensor, to achieve flow limited more by inertia than viscosity. Distinct high-flow and low-flow control regimes are used. For high flow, bolus volume is maximized by pulsing for one-half the fluid oscillation period determined by the volume sensor fluid capacitance and the flow inertia of the fluid passageway, shutting off at flow reversal. For low flow, pulses typically below 10% of the high-flow pulse width yield small bolus volumes varying as the square of pulse width, providing control over a wide dynamic range of bolus sizes down to fractions of a microliter, permitting moderately high pulse frequencies even at very low average rates, achieving nearly continuous flow to create the distribution of water pixels contemplated in the present technology. Design with normally-closed, energize-to-open valves assures flow stop if power is lost. In this context, the large fluid passageways lead to a prescribed volume transfer at low valve-open duty cycle, conserving energy and making battery operation practical.

The digital software signals directly correspond to on (segment flowing out of nozzle or cannon head) and off (water ceasing flow to create a space before the next segment).

On a smaller scale, a frame (e.g., a rectangular frame) with liquid inlets along the interior edges of the frame and corresponding outlets for removal of liquid may be provided (e.g., dimensions of less than 5 meters/side, less than 3 meters/side or less than 1 meter/side). The speed of flow of the liquid (either within a tube or free moving) may be controlled to provide the pixels for the liquid image. The direction of projection from the sides may be horizontal, vertical, obtuse or acute with respect to the side to implement visual effects.

The technology described herein includes apparatus and methods for providing a visible image in a digital format over an at least 2-dimensional area by emitting liquid in segments with spacing, the segments acting as pixels within the image. The method may be for providing a visible image in a pointillism format over an at least 2-dimensional area by emitting liquid in segments with spacing, the segments acting as points within the image. The water preferably is projected upwardly (close to 90 degree vertical with respect to a base plane) in segments with spacing or downwardly in segments with spacing. The method should provide the at least 2-dimensional area with at least 50 or at least 100 segments at a time in a viewing area. A backdrop may be provided behind the 2-dimensional area to increase contrast of the image or the segments may move along a solid support surface. The solid support surface may be bent to affect the perceived relative speed and spacing of segments from a line of sight or the 2-dimensional area is a flat surface on which the segments are directed and the segments continue to move under force of gravity. The flat surface may be a hydrophobic surface. The flat surface may physically support the segments as a support plane from a position generally below the segments in contact with the flat surface. A path for segments forming the visible image may be confined within a frame having at least one transparent or translucent surface within the frame lying parallel to the path for the segments.

An apparatus for providing an image according to the methods described herein may comprise a source of liquid, a set of at least 5 water cannons or 5 water jets that emit liquid streams from the source of liquid, valves on the water cannons or water jets that restrain emission of water from the water cannon or water jets while the liquid is at a pressure in excess of 1.2 atmospheres, electronic controls on the valves that enable full opening or full closing of the valves in less than 10 milliseconds, and a computer independently directing the operation of the electronic controls for each of the water cannons or water jets to provide emitting liquid in segments with spacing. For larger fountain displays, the water cannons may be partially submerged in a pool of water and sufficient water pressure provides liquid with pressure in excess of 2 atmospheres. For smaller displays, there may be at least 10 water jets or water cannons, and a path is defined for segments between panels, with at least one panel being transparent or translucent. In the small image format, the electronic controls on the valves should enable full opening or full closing of the valves in less than 1 millisecond.

Although specific materials and designs have been described, these specifics should not be interpreted as limiting the generic scope of the technology described herein. This technology should be considered within the alternatives and substitutions that would be readily used by one skilled in the art.

What is claimed:

1. A method of providing a visible image in a digital format over an at least 2-dimensional area by emitting liquid in segments with spacing, the segments acting as pixels within the image.

2. A method of providing a visible image in a pointillism format over an at least 2-dimensional area by emitting liquid in segments with spacing, the segments acting as points within the image.

3. The method of claim 1 wherein water is projected upwardly in segments with spacing.

4. The method of claim 1 wherein water is projected downwardly in segments with spacing.

5. The method of claim 1 wherein the at least 2-dimensional area has at least 50 segments at a time in a viewing area.

6. The method of claim 1 wherein the at least 2-dimensional area has at least 100 segments at a time in a viewing area.

7. The method of claim 5 wherein a backdrop is provided behind the 2-dimensional area to increase contrast of the image.

8. The method of claim 4 wherein the segments move along a solid support surface.

9. The method of claim 8 wherein the solid support surface is bent to affect the perceived relative speed and spacing of segments from a line of sight.

10. The method of claim 1 wherein the 2-dimensional area is a flat surface on which the segments are directed and the segments continue to move under force of gravity.

11. The method of claim 10 wherein the flat surface is a hydrophobic surface.

12. The method of claim 11 wherein the flat surface supports the segments from a position below the segments.

13. The method of claim 5 wherein a path for segments forming the visible image is confined within a frame having at least one transparent or translucent surface within the frame lying parallel to the path for the segments.

14. A method for providing an image according to the method of claim 1 comprising a source of liquid, a set of at least 5 water cannons or 5 water jets that emit liquid streams from the source of liquid, valves on the water cannons or water jets that restrain emission of water from the water cannon or water jets while the liquid is at a pressure in excess of 1.2 atmospheres, electronic controls on the valves that enable full opening or full closing of the valves in less than 10 milliseconds, and a computer independently directing the operation of the electronic controls for each of the water cannons or water jets to provide emitting liquid in segments with spacing.

15. The apparatus of claim 14 wherein the water cannons are partially submerged in a pool of water and sufficient water pressure provides liquid with pressure in excess of 2 atmospheres.

16. The method of claim 14 wherein there are at least 10 water jets or water cannons, and a path is defined for segments between panels, with at least one panel being transparent or translucent.

17. The method of claim 16 wherein electronic controls on the valves that enable full opening or full closing of the valves in less than 1 millisecond.
